(19) United States
(12) Patent Application Publication
(10) Pub. No.: US 2011/0129048 A1
(43) Pub. Date: Jun. 2, 2011

(54) SYNCHRONIZED SYSTEM FOR DISTRIBUTING AND PROCESSING SIGNALS, IN PARTICULAR AUDIO SIGNALS IN A WIRELESS LOUDSPEAKER NETWORK

(75) Inventors: Christophe Barbe, Antony (FR); Yves Lemoine, Paris (FR); Pierre Pignal, Paris (FR)

(73) Assignee: PARROT, Paris, FR (FR)

(21) Appl. No.: 12/675,931

(22) PCT Filed: Aug. 26, 2008
(86) PCT No.: PCT/FR08/01207

§ 371 Date: Mar. 1, 2010

(30) Foreign Application Priority Data
Sep. 6, 2007 (FR) 07 06236

(51) Int. Cl. H04L 7/00

(52) U.S. Cl. 375/371

(57) ABSTRACT

The system comprises a master device (10) and at least one slave device (20). Each device has wireless transceiver and interface means (12, 22), a digital signal processor (14, 24), and a clock (16, 26). The master device transmits signals at a rate defined by its clock (16). The slave device has means for determining the frequency offset between the clocks and for correcting accordingly the rate at which signals are delivered internally to its processor. At the slave end, the frequency of the external clock(s) (26) is controllable about its nominal value, and means are provided for extracting a frequency offset value from a register (50) and for responding thereto by adjusting the frequency of the second clock in the direction tending to minimize the offset. The processor (24) of the slave device is thus enabled to operate synchronously with the clocking of signals delivered over the wireless connection, as played back by the interface circuit after the clock rate of the signals has been corrected internally.

The invention relates to signal distribution systems including at least two devices that are coupled together in continuous manner by a wireless connection.

The invention applies most advantageously to wireless connections of the Bluetooth type (registered trademark of Bluetooth SIG, Inc.).

The specifications of Bluetooth provide for the possibility of remotely controlling a remote device over a bidirectional wireless connection. In practice, the remote device is usually a mobile telephone or a computer peripheral, however the Bluetooth specifications are not limited to appliances of that type and they include in particular profiles that are compatible with transmitting high-quality coded multichannel audio streams (advanced audio distribution profile (A2DP)), and also profiles that provide interoperability of Bluetooth appliances with audio and video control functions (audio video remote control profile (AVRCP)).

Bluetooth technology is particularly advantageous given its universal and evolving nature, the existence of numerous functions, and also of numerous components specially designed for implementing it, which components are also inexpensive. Nevertheless, this choice of technology is not limiting in anyway, and the wireless connection may be implemented by means of other wireless transmission techniques, providing such techniques present a data rate that is sufficient to enable a continuous data stream to be transmitted (e.g. high-quality digital audio or video signals): this applies for example to the so-called “WiFi” IEEE 802.11 standard (ISO/IEC 8802-11).

The invention relates most particularly, but in non-limiting manner, to systems for distributing audio signals between a plurality of active loudspeakers that communicate with one another by wireless transmission means in order to play back signals from an audio source via the various respective loudspeakers.

One such system is described in particular in document WO 07/074,245 A1 (Seydoux).

In that system, each loudspeaker includes means, advantageously Bluetooth type means, for providing a wireless interface with any other loudspeaker of the system. The loudspeakers configure themselves automatically into a network, drawing up a table of mutual visibilities and defining, on the basis of said table, a hierarchical network topology, with one of the loudspeakers being designated “network head”. Amongst other functions, the network head has the function of establishing a connection (which may be wired, or is preferably wireless) with a remote peripheral that is producing a coded audio signal or a remote control signal. The other loudspeakers receive signals intended for them that are encapsulated in messages that include routing data and that are distributed within the network from the head loudspeaker, either directly or after said signals have been relayed by some other loudspeaker in the system.

Insofar as the various active loudspeakers of the system are physically independent (the only constraint being that the loudspeakers need to be connected to a power outlet), each loudspeaker has its own clock, serving to control its various circuits, in particular its Bluetooth transceiver and interface circuit and the digital signal processing circuit, generally grouped together in a specific digital signal processor (DSP).

The audio data is streamed, i.e. it is delivered as a continuous stream between the various loudspeakers from the network head loudspeaker, which acts as a server in a client/server architecture, with the other loudspeakers being client loudspeakers.

Distribution by streaming requires the client (receiver) to consume the data that is transmitted thereto at the same rate as the data is transmitted by the server (the source). If the client consumes data too slowly, then, sooner or later, it will have an overload of non-consumed data, with its interface buffer overflowing; conversely, if it consumes data too fast, then sooner or later the client will be short of data, with its buffer underflowing.

To avoid this difficulty, Bluetooth specifications require all paired devices to possess a clock that is very accurate, to within ±20 parts per million (ppm). This requirement applies to devices of all types, even those acting in a privileged position such as master devices in a master/slave network of the piconet or scatternet type.

The remaining variability between the clocks of the various devices is managed by using a mechanism that consists in recognizing a particular binary pattern in low level packets, and then in adding or subtracting an offset that enables sequencing to be corrected so as to obtain the desired synchronization.

By way of example, such a technique is described in US 2003/203729 A1, which in order to compensate for the offset of different clocks, makes provision for using a mechanism for recognizing a particular pattern in identifiable packets in order subsequently to add or subtract ticks (pulses) to or from time slots specified by the transmission protocol for the purpose of correcting the sequencing and obtaining the desired synchronization—but in a manner that is internal solely to the radio frequency (RF) circuit. This makes it possible to have the same data rate between the transmitter device and the receiver device.

Other documents describe various ways of managing lack of synchronization.

Thus, US 2005/181729 A1 provides particular servo-control of the clock of a receiver device so as to be able to operate it at a low level under certain circumstances, thereby optimizing energy consumption. The processing performed takes place exclusively at the level of the RF circuit, internally thereto, so as to correct for transmission anomalies that appear in the RF connection, but without having any incidence on other application circuits located downstream from the RF circuit.

WO 02/073851 A1 describes a device in which the frequency proper of the clock is not modified, the device being content merely to update an offset value used for managing the addition or subtraction of compensation pulses.

The document “Clock Sync Protocols as Submitted to the p1394.1 Committee” by D. V. James, Oct. 12, 1999, XP-002247442 describes a configuration in which a plurality of devices are chained together in series. In order to avoid resynchronization errors accumulating, which might lead to a cascade effect, the value of the correction to be applied is transmitted all along the chain so that it can be identified by each of the peripherals of the serial bus. That constitutes a very particular topology, and a problem that is specific to that topology, and that does not arise in configurations of the piconet or scatternet type such as those provided for in Bluetooth specifications.

In general, the technique of managing lack of synchronization in Bluetooth specifications is implemented in the chipset that performs the radio and interfacing functions of Bluetooth.

That technique makes it possible at the outputs from the respective chipsets of all of the devices in the network, to obtain transmitted data that is synchronized on a common clock.

In contrast, since the management of lack of synchronization is purely internal to each RF chipset, it is not forwarded to components external to the chipset, i.e. to the digital circuit for processing the signal played back at the output from the chipset—and specifically the DSP for implementing the particular application of the network and that makes use of the signals delivered by the chipset.

As a general rule, this aspect is of no consequence, since Bluetooth technology is designed for spot transmission of data over a short duration, e.g. the duration of a telephone conversation, or the time required to send a file to a printer.

However, in the particular circumstance of an audio system as described in above-mentioned WO 07/074,245 A1, Bluetooth technology is used in a manner that is somewhat different from its original purpose—but without modifying its protocols, so as to remain fully compatible with the provisions of Bluetooth specifications.

In that particular system, Bluetooth technology is used for establishing a permanent connection within the system, which connection continues so long as the loudspeakers have not been switched off, i.e. physically disconnected from a mains outlet. More precisely, while the system is on standby, i.e. apparently inactive so far as a user is concerned, the wireless connections between the various loudspeakers remaining active, albeit with low information traffic, so as to enable the wireless configuration to be maintained and so as to enable the network to respond at any instant to detect the appearance of an external signal.

The connection may thus be maintained continuously and persistently for several hours or several days without interruption.

Since each device is provided with its own clock (a clock external to the chipset), if the RF connection is maintained continuously without interruption—a situation that is unusual for a Bluetooth connection—, then a progressive loss of synchronization will appear between the clocking of the received signal streams (as already corrected internally by the resynchronization process of the RF chipset), and the clocking of the DSP that is processing the signals. Although this drift is small, it can lead to incidents in the processing of the signal by the DSPs, particularly since the clock is inaccurate, given the way in which various losses of synchronization accumulate rapidly.

That is why, in known devices, in addition to selecting a clock that presents relatively high accuracy (typically ±2 ppm), provision is made to force resynchronization at periodic intervals, e.g. once every two hours.

Usually, such resynchronization passes unnoticed, but that way of proceeding is nevertheless unsatisfactory, and it would be desirable to be able to avoid such a mechanism completely.

In addition to eliminating periodic resynchronization, it would also be advantageous to be able to use a device having a clock that is less accurate (up to ±20 ppm instead of ±2 pm), and therefore less expensive and simpler to implement.

To achieve this object, the solution proposed by the invention consists essentially in:
searching from within the RF chipset the offset value that has been used for internal resynchronization;
externalizing said offset value; and
using it to control the DSP (or any other application circuit external to the RF chipset) so as to resynchronize the DSP and achieve an accurate match between i) the received data stream as delivered by the RF chipset, and ii) the clocking rate at which the data is processed by the DSP.

More precisely, the invention relates to a signal distribution system of the type disclosed for example in above-mentioned WO 07/074,245 A1, i.e. having at least two devices that are coupled together in continuous manner by a wireless connection, comprising a master device and at least one slave device.

The master device has first transceiver and interface means, a first digital signal processor, and a first clock, for common clocking of the first transceiver and interface means and of the first digital processor, so as to transmit signals over the wireless connection that are at a clock rate defined by said first clock. The slave device has second transceiver and interface means, a second digital signal processor, and a second clock for common clocking of the second transceiver and interface means and of the second digital processor. The second transceiver and interface means include internal resynchronization means with internal correlator and compensator means for determining a frequency offset between the clock rate of the signals received by the second transceiver and interface means and the frequency of the second clock, and to correct the rate at which signals are delivered to the second digital processor by the second transceiver and interface means as a function of the frequency offset as determined in this way.

In a manner characteristic of the invention, the second clock is a clock that is external relative to the above-mentioned second transceiver and interface means, and of frequency that can be controlled about its nominal value, and the slave device further includes interrogator means for extracting the value of said frequency offset from the correlator and compensator means, and servo-control means for applying the offset as extracted in this way to the second clock in such a manner as to control the frequency of the second clock in response to said frequency offset value in the direction tending to minimize said offset.

Most advantageously, the interrogator means are means incorporated in the second digital processor for reading the content of a register that is internal to the correlator and compensator means.

Preferably, the second digital processor includes means for delivering a signal for controlling the frequency of the second clock, in particular a digital signal such as a pulse width modulation signal that is delivered to the second clock via a lowpass filter.

The accuracy of the first and second clocks may thus be as poor as 10 ppm or more, preferably 20 ppm or more.

There follows a description of an embodiment of the invention with reference to the accompanying drawings in which the same numerical references are used from one figure to another to designate elements that are identical or functionally similar.

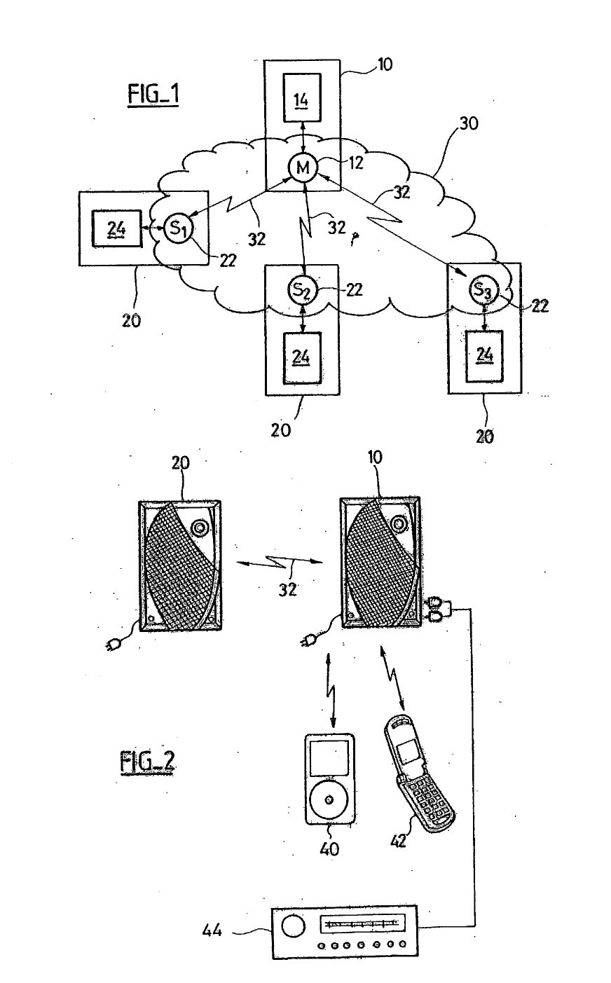

FIG. 1 is a diagram showing the various devices of a system in which signal distribution is provided by wireless means.

FIG. 2 is a diagrammatic view of the various elements of an audio signal distribution system in a wireless loudspeaker network.

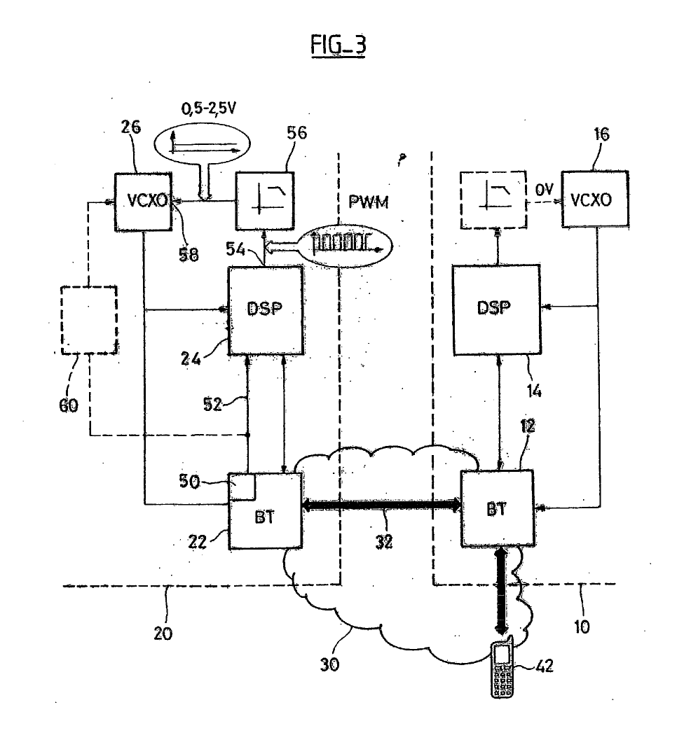

FIG. 3 is a block diagram of various elements used for implementing the invention in the system of FIG. 2.

FIG. 1 is a diagram showing a network made up of a plurality of devices interchanging signals by wireless means, e.g. via Bluetooth type connections. Nevertheless, as stated in the introduction, selecting this particular technology is not in any way limiting on the invention, which may be applied using other wireless transmission techniques operating in comparable manner.

The Bluetooth specifications make it possible not only to establish point-to-point connections between two elements, but also to establish and to manage networks of greater or smaller complexity made up of a certain number of such elements.

A first type of network is a “piconet”, i.e. a very small network that sets itself up in automatic manner when a plurality of Bluetooth-compatible elements are within range of one another. The piconet uses a star topology with a master 10 and a plurality of slaves 20: communications are direct between the master 10 and the slaves 20, while the slaves 20 cannot communicate with one another.

More precisely, each master or slave device 10 or 20 includes a Bluetooth transceiver and interface circuit given a respective reference 12 or 22. The master circuit M (the circuit 12) communicates with each of the slave circuits S₁, S₂, S₃, . . . (the circuits 22) via respective connections 32. These circuits 12 and 22 thus form a wireless network 30 having a master M (with the circuit 12) and a plurality of slaves S₁, S₂, S₃ (with the circuits 22).

Each device 10, 20 also includes, in addition to the transceiver and interface circuit 12, 22, a specific application circuit 14, 24 for processing the data exchanged within the wireless network 30 by the various devices. It should be observed that functionally speaking these application circuits 14, 24 lie outside the network 30, which itself serves merely to exchange signals and does not have any application function.

FIG. 2 shows a specific example of such a network, as applied to distributing audio signals.

In this system, the devices are active loudspeakers that are mutually configured in a wireless network, including a loudspeaker 10 that constitutes a master loudspeaker and one or more other loudspeakers 20 constituting one or more slave loudspeakers. For simplicity, the system shown is a stereo system having only two loudspeakers, however a system having a larger number of loudspeakers could be implemented in the same way, in particular in an installation of the “home cinema” type having sound configurations of the “5.1”, “7.1”, etc. type including various surround-sound satellites, a woofer, etc.

The master loudspeaker 10 may be coupled to various peripherals, e.g. to a digital player 40 provided with a Bluetooth module (internal or external) transmitting an audio stream to the system using an A2DP profile, or indeed a mobile telephone 42 sending audio data to the system in the same manner. The peripherals may also be control peripherals that send control signals to the system using an AVRCP profile. The peripheral may also be a peripheral suitable for sending both audio signals and commands, e.g. the mobile telephone 42 having keys that are suitable for being used to control the system (select sources, volume, balance, . . . ).

The system may also be connected to traditional elements 44 such as an FM tuner, a CD or DVD player/recorder, a TV set, etc., via a wired connection using plugs connected to corresponding sockets provided in the loudspeaker 10.

As shown by the block diagram of FIG. 3, the Bluetooth transceiver and interface circuit 12 of the loudspeaker 10 delivers signals to an application circuit 14 constituting a digital signal processor (DSP). The digital circuits 12 and 14 of the loudspeaker 10 are clocked by a common clock 16, e.g. a clock having a nominal frequency of 26 megahertz (MHz) with stability of the order of ±20 ppm.

The slave loudspeaker 20 comprises in the same manner a Bluetooth transceiver and interface circuit 22 that delivers signals to an application circuit 24 constituted by a DSP. The digital circuits 22 and 24 of the loudspeaker 20 are clocked by a common clock 26, e.g. a clock having a nominal frequency of 26 MHz and stability of the order of ±20 ppm.

The clocks 16 and 26 of the two loudspeakers 10 and 20 of the system have the same nominal frequency, but, in actual fact, their real frequencies always present a small departure from the nominal value.

Concerning data transmission between the two circuits 12 and 22 (wireless connection 32), it is explained above how Bluetooth specifications provide means for compensating this difference with an offset being added or subtracted at the slave end from each data packet, the offset corresponding to the observed frequency difference.

The offset from the nominal frequency is detected by a correlator suitable for observing the data stream and recognizing therein a particular pattern or sequence of bits as sent at the beginnings of packets, for analyzing time position, and consequently for determining the necessary offset. The correction has the effect that the data stream at the output from the circuit 22 presents exactly the same clocking as that at the output of the circuit 12 of the remote master device.

However this resynchronization remains internal to the network, i.e. it applies only to the radio interface circuits 12, 22.

In a manner characteristic of the invention, the offset determined by the circuit 22 is used also to resynchronize the digital application circuit 24 of the slave device.

The circuit 24 is controlled to read a register 50 that is internal to the circuit 22 and that contains the value of the offset as determined by the Bluetooth correlator. This register, known as Clock Offset in Bluetooth specifications, contains the value of the time offset between the clock signal at the master end and the clock signal at the slave end, together with a validity flag. The link 52 represents the circuit 24 reading the contents of the register 50.

The value read in this way enables the circuit 24 to determine whether the clock 26 at the slave end is fast or slow relative to the clock 16 at the master end.

On the basis of this observation, the base frequency of the clock 26 at the slave end is adjusted to make it as synchronous as possible with the frequency of the clock 16 at the master end (it should be observed that this adjustment takes place at the slave end only, since Bluetooth specifications prohibit any action on the clock at the master end).

In other words, this operation consists in externalizing the offset contained in the register so as to apply it to the main clock.

By way of example, regulation of the clock 26 is controlled by a digital output 54 of the circuit 24 that delivers a pulsed width modulated (PWM) signal.

This digital signal is used to generate a clock control voltage, e.g. by means of a second-order lowpass filter 56 having a cutoff frequency of about 10 Hz.

The DC voltage obtained at the output from the filter 56, e.g. lying in the range 0.5 volts (V) to 2.5 V, thus represents the value of the offset between the clocks of the two devices 10 and 20.

This value is applied to a control input 58 of the clock 26, which clock is a voltage-controlled crystal oscillator (VCXO). By varying the voltage applied to the input 58 over a range extending from 0.5 V to 2.5 V, it is possible to adjust the frequency generated by the clock 26 over a range of −8 ppm to +8 ppm.

The application circuit 24 that serves to process the received data can thus be accurately synchronized on the frequency of the network clock without any wire serving to transfer data between the various devices.

Specifically, in order to achieve uniformity, provision is made for all of the devices to have the same internal structure, with it only being at the time of automatic network configuration that any particular device is defined as being a master or a slave. Insofar as the corrections are applied only to slave devices and not to the master device, it suffices for the master device to apply a null voltage to the oscillator control input of the clock 16. Thus, the VCXO at the master end behaves like a simple crystal oscillator, oscillating at its nominal frequency with a certain amount of inaccuracy, while frequency is compensated at the slave end.

1. A signal distribution system, in particular for radio signals in a wireless loudspeaker network, the system comprising at least two devices (10, 20) that are continuously coupled together by a wireless connection (32), and comprising:
a master device (10) comprising:
first transmission and interface means (12);
a first digital signal processor (14); and
a first clock (16) for common clocking of the first transmission and interface means and of the first digital signal processor;
the master device transmitting signals via said wireless connection (32) at a rate that is defined by said first clock (16);
at least one slave device (20) comprising:
second transmission and interface means (22);
a second digital signal processor (24); and
a second clock (26) for common clocking of the second transmission and interface means and of the second digital signal processor;
the second transmission and interface means (22) including internal resynchronization means, having internal correlator and compensator means for determining a frequency offset between firstly the clock rate of the signals received by the second transmission and interface means, and secondly the frequency of the second clock, and for correcting the rate at which signals are delivered to the second digital signal processor by the second transmission and interface means as a function of the frequency offset as determined in this way;
the system being characterized in that the second clock (26) is a clock that is external relative to said second transmission and interface means, and presents a frequency that is controllable about its nominal value; and
in that the slave device further comprises:
interrogator means for extracting the value of said frequency offset from the correlator and compensator means; and
servo-control means (54, 56, 58) for applying said offset as extracted in this way to the second clock so as to control the frequency of the second clock in response to said frequency offset value, in the direction tending to minimize said offset.

2. The system of claim 1, wherein the interrogator means are means (52) for reading the content of an internal register (50) of the correlator and compensator means.

3. The system of claim 1, wherein the interrogator means are incorporated in the second digital processor (24).

4. The system of claim 1, wherein the second digital signal processor (24) includes means for delivering a signal (54) for controlling the frequency of the second clock.

5. The system of claim 4, wherein the control signal (54) is a digital signal.

6. The system of claim 5, wherein the control signal (54) is a pulse width modulated (PWM) signal.

7. The system of claim 6, wherein the control signal (54) is delivered to the second clock (26) via a lowpass filter (56).

8. The system of claim 1, wherein the accuracy of the first and second clocks (16, 26) is at best 10 ppm, and preferably at best 20 ppm.
